(19) United States
(12) Patent Application Publication
(10) Pub. No.: US 2011/0076146 A1
(43) Pub. Date: Mar. 31, 2011

(54) Wind turbine electrical generating system with combined structural support members and straightening vanes

(76) Inventors: Andrew J. Falcone, Winsted, CT (US); Clark David Anderson, Barkhamsted, CT (US); Brendan Savio Mascarenhas, Burlington, CT (US); Drew M. Rocky, Sherman, CT (US); David Hinman Leach, Torrington, CT (US); Russel Hugh Marvin, Goshen, CT (US)

(21) Appl. No.: 12/586,998

(22) Filed: Sep. 30, 2009

(51) Int. Cl. F03D 1/02; F03D 11/04

(52) U.S. Cl. 416/120; 416/244 R

(57) ABSTRACT

A wind turbine electrical-generating system with air-directing vanes in the forms of sheaths over structural members crossing the sir discharge opening of the wind turbines. The turbines also have associated shroud assemblies which support the structural members and which cooperate with the vanes to provide superior performance.

### BACKGROUND OF THE INVENTION

In order to generate sufficient electrical energy wind turbines must be of substantial diameter and supported for operation on towers at considerable elevations. Obviously, structural supporting members for mounting the turbines on the towers must be of substantial size and strength and their location is in most cases if not all at least partially in the path of the discharge flow from the turbines. With axial flow turbines the discharge flow has a swirling component, which is detrimental to turbine performance, and the interaction of this flow with the supporting structure also results in drag and a further detrimental effect on turbine performance.

Accordingly, it is the general object of the present invention to provide means for reducing the detrimental effect of structural supporting members in the discharge flow of a wind turbine and at the same time reducing swirling in the discharge flow.

A further object resides in the provision of the foregoing in combination with a shrouded wind turbine.

A still further object is to provide the foregoing means in an inexpensive yet highly efficient form.

### SUMMARY OF THE INVENTION

Stationary vanes for directing the flow of air or other fluids have long been used in a wide variety of different environments. It is believed, however, that they have not been used in composite form in combination with structural supporting members for wind turbines.

In accordance with the present invention and in fulfillment of the foregoing objects, at least one axial flow wind turbine is provided together with at least one elongated structural member for supporting the same at elevation on a tower. The supporting member extends in a generally radial outward direction relative to the axis of the turbine and rearwardly of the turbine so as to be in the swirling discharge flow of the turbine. An elongated sheath envelops the structural member and has an airfoil configuration in cross section to both reduce the drag of the structural member and straighten the swirling discharge flow.

Preferably, the structural member takes the form of a metallic truss comprising interconnecting lateral members extending between a pair of parallel elongated tubular members spaced apart and offset axially to fit within a sheath having an optimum cambered airfoil configuration for straightening the swirling discharge air stream.

The sheath is preferably of lightweight inexpensive extruded thermoplastic construction and both the sheath and the structural member are designed for relative sliding assembly with each other. The sheath is also somewhat shorter than the structural member to accommodate thermal expansion and may have a single point of attachment with the structural member or may be held in place by friction alone again for accommodation of thermal expansion and contraction.

In an illustrative embodiment of the invention three (3) wind turbines are mounted in pairs on opposite sides of a supporting tower and each turbine has at least one supporting member and an associated sheath for reducing drag and straightening the air stream discharged from its turbine. The supporting member and sheath extend generally radially but are preferably inclined slightly rearwardly from a precisely radial plane in a more or less cone shaped configuration. An accelerator is also preferably provided and divides approaching wind into a pair of diverging air streams respectively entering and passing through the turbines.

It should also be noted that shrouded turbines are particularly well suited to combination with the present invention and with the enhanced performance from shrouding taken together with performance gains from sheathing of the present invention superior overall turbine performance is achieved. A synergistic result is thus realized when sheathed structural members and turbines are supported by shroud assemblies with a number of structural members extending radially in a common plane and each connected at opposite ends to a shroud assembly and a hub assembly for the turbine.

### DESCRIPTION OF THE DRAWINGS

FIG. 1 is a front view in elevation showing a tower supporting three (3) pairs of wind turbines,

FIG. 2 is an enlarged view of an illustrative wind turbine, hub, shroud and exposed structural member assembly,

FIG. 3 is an enlarged illustrative view of a wind turbine, hub, shroud and completed vane assembly,

FIG. 4 is an enlarged cross-sectional view of a structural member and sheath forming a vane assembly,

FIG. 5 is a perspective view of a sheath and,

FIG. 6 is a fragmentary view showing a sheath and structural member of a vane assembly.

### DESCRIPTION OF PREFERRED EMBODIMENT

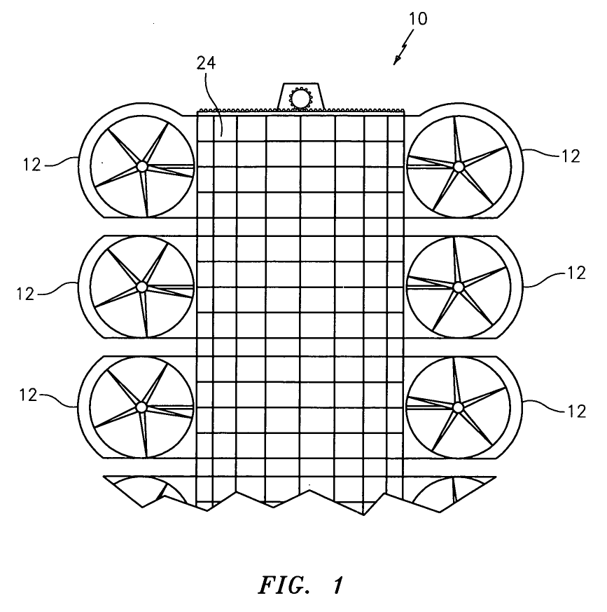

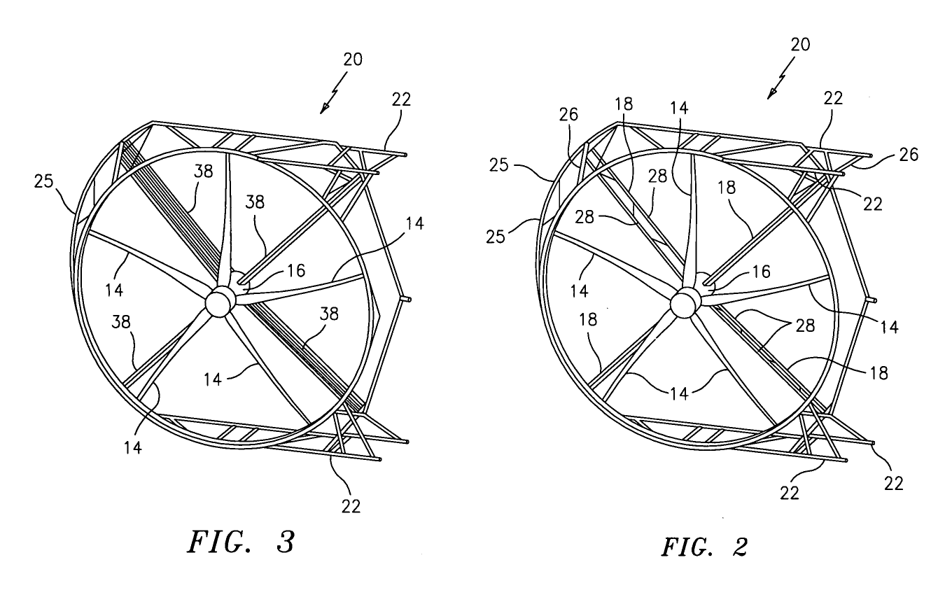

Referring particularly to FIG. 1, a tower partially shown and indicated generally at 10 supports three (3) pairs of wind turbine assemblies 12, 12. As more clearly shown in FIGS. 2 and 3, each wind turbine assembly comprises an axial flow wind turbine having five (5) blades 14, 14 supported in common on a hub assembly 16. The hub assembly 16 is supported by four (4) structural members 18, 18 which extend generally and, more specifically, in a direction inclined rearwardly from the radial, each with an inner end portion connected with and supported by the hub assembly 16. At their outer end portions the structural members 18, 18 are connected with a shroud assembly indicated generally at 20. The shroud assembly includes a lattice type structure having upper and lower spaced parallel and horizontal members 22, 22 that are supported by the tower 10. More specifically, the members 22,22 extend to and are connected with the structural members, not shown, within an accelerator 24 which are in turn supported by main structural members of the tower 10. The members 22, 22 of the shroud assembly support arcuate members 25,25 that in turn mount an arcuate shroud, not shown. Short lateral truss members 26, 26 extend between the members 22, 22 and members 24, 24 and support the outer end portions of the aforesaid radial structural members 18, 18.

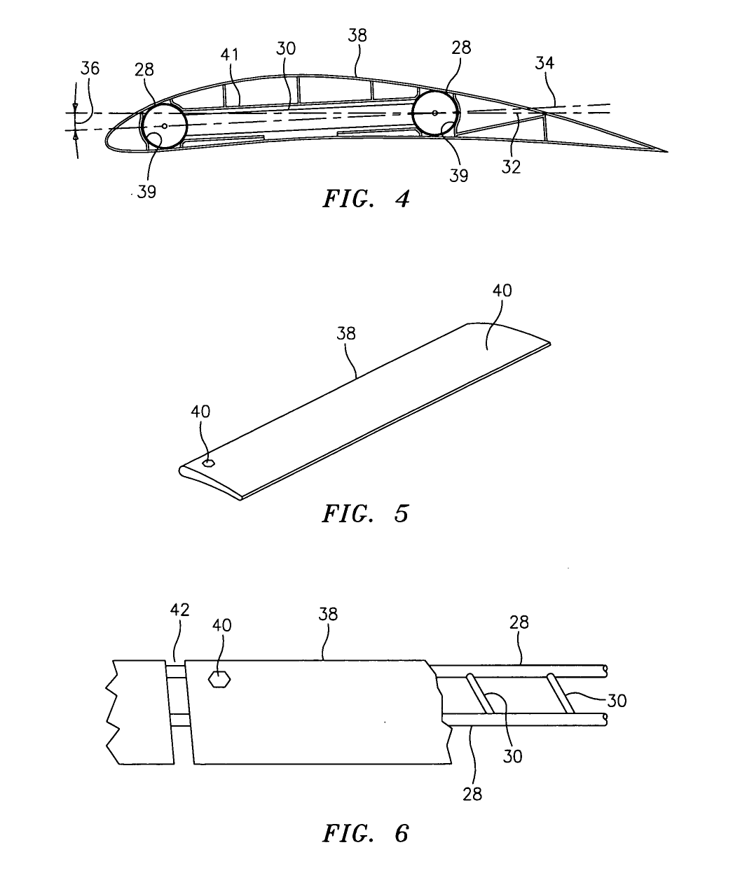

The structural members 18,18 preferably take the form of trusses with a pair of elongated spaced apart parallel tubular members 28, 28 extending longitudinally and connected by transverse truss members 30, 30, FIGS. 2, 4, and 6. The tubular structural members 28, 28 are spaced apart axially as illustrated in FIG. 4 with the turbine axis depicted by broken line 32. The members 28, 28 are also offset axially as illustrated by the relationship between the axis line 32 and the broken centerline 34 of the tubular members, the lines 32 and 34 being angularly displaced as illustrated at 36 in FIG. 4. The structural members 18, 18 are of metallic construction, and the specific material may vary but is preferably galvanized steel.

FIGS. 3, 5, and 6 illustrate an elongated sheath 38 in the shape of an airfoil which forms an air-directing vane of the present invention. As best illustrated in FIG. 4 the sheath 38 has a number of integral strengthening members which extend throughout its length within its interior cavity together with spaced apart elongated and parallel cylindrical openings 39,39 which slidably receive the aforementioned parallel tubular members 28, 28. An open channel 41 extending between the two cylindrical openings 39,39 receives the transverse truss members 30, 30 of the structural member 18. The sheath is also provided with a camber, which together with the axial offset of the structural members results in an optimum airfoil configuration.

As will be apparent, the sheaths 38,38 and the structural members 18, 18 may be readily assembled in a relative sliding operation. The sheaths 38, 38 and structural members 18, 18 may be maintained in their assembled relationship merely with the aid of friction or, alternatively, a single point of positive attachment may be provided as with a bolt 40 in FIG. 5 The bolt 40 penetrates the sheath and connects with the structural member 28. Thus, thermal expansion and contraction of the sheath relative to the structural member is accommodated. Further, in accommodation of thermal expansion the sheath 38 is spaced slightly in a longitudinal direction from the hub 16 as illustrated at 42 in FIG. 6.

As mentioned above, and as will now be apparent, the “anti-swirl” vanes of the present invention eliminate drag otherwise encountered with the support structure for the wind turbines, reduce swirl in the discharge air streams of the turbines, and cooperate with the shrouds to provide superior performance of the wind turbines.

1. In a wind turbine electrical generating system; the combination of a supporting tower, at least one axial flow wind turbine mounted on the tower at elevation for enhanced air flow therethrough, the air stream discharged from the turbine having a natural swirling configuration, at least one elongated structural member supporting the turbine on the tower and extending in a generally radially outward direction relative to the axis of the turbine and rearwardly of the turbine, and an elongated hollow sheath enveloping the at least one structural member and having an external airfoil configuration in cross section tending to reduce drag caused by the structural member and straighten the swirling airflow discharged from the turbine whereby to enhance turbine performance.

2. The combination set forth in claim 1 wherein the structural member extends generally in a direction inclined rearwardly from the radial.

3. The combination set forth in claim 1 wherein the structural member is metallic and in the form of a truss.

4. The combination set forth in claim 1 wherein the sheath is of thermoplastic construction.

5. The combination set forth in claim 1 wherein the structural member comprises a pair of axially spaced parallel metallic members spaced apart within a sheath having an optimum airfoil configuration for straightening the swirling air stream.

6. The combination set forth in claim 1 wherein the airfoil shaped sheath is cambered.

7. The combination set forth in claim 1 wherein the sheath is extruded, and wherein the structural member and sheath are designed for relative sliding assembly with each other.

8. The combination set forth in claim 7 wherein the sheath is of thermoplastic construction.

9. The combination set forth in claim 1 wherein the sheath is somewhat shorter than the structural member to accommodate thermal expansion of the former.

10. The combination set forth in claim 1 wherein the sheath is frictionally attached to the structural member to accommodate thermal expansion and contraction of the sheath.

11. The combination set forth in claim 1 wherein the sheath has only a single point of positive attachment to the structural member to accommodate thermal expansion and contraction.

12. The combination set forth in claim 1 wherein at least one pair of similar wind turbines is provided with one turbine disposed on each side of the supporting tower and with each turbine having at least one supporting structural member with an associated sheath for straightening air discharged therefrom.

13. The combination as set forth in claim 12 wherein an accelerator is provided on the tower to divide approaching wind into a pair of diverging air streams respectively entering and passing through said pair of turbines.

14. The combination as set forth in claim 1 wherein said wind turbine is provided with a shroud assembly in turn mounted on said tower structure, and wherein said structural member associated with said turbines is supported by said shroud assembly.

15. The combination set forth in claim 14 wherein said turbine has a hub assembly and four associated structural members each of which extends in radial relationship with the air discharge opening of its turbine with its opposite ends secured to the hub and shroud assemblies.

16. The combination as set forth in claim 15 wherein each of said structural members comprises a pair of axially spaced parallel tubular members off set axially to fit within a sheath having an optimum airfoil configuration for straightening the swirling air stream.
